(19) United States
(12) Patent Application Publication
(10) Pub. No.: US 2022/0117832 A1
(43) Pub. Date: Apr. 21, 2022

(54) PRESSURE RELEASE AND MASSAGE TOOL

(71) Applicant: Aletha Inc., Walnut Creek, CA (US)

(72) Inventor: Christine Annette Koth, Walnut Creek, CA (US)

(73) Assignee: Aletha Inc., Walnut Creek, CA (US)

(21) Appl. No.: 17/646,468

(22) Filed: Dec. 29, 2021

Related U.S. Application Data
(63) Continuation-in-part of application No. 16/850,801, filed on Apr. 16, 2020.
(60) Provisional application No. 62/860,222, filed on Jun. 11, 2019.

(51) Int. Cl. A61H 7/00

(52) U.S. Cl. CPC A61H 7/001; A61H 2201/1253; A61H 2203/0456; A61H 2201/1635; A61H 2201/1676

(57) ABSTRACT

Device and method for relieving muscle tension. The device includes a base, two pivots coupled to the base, and two moveable arms. Each moveable arm is coupled to the base via one of the two pivots. Each moveable arm includes a tip, an extension portion coupled to the tip, and a handle connected to the horizontal portion. The extension portion includes a vertical portion coupled to the tip and a horizontal portion coupled to the vertical portion. Each of the moveable arms is configured to provide angular pressure against a targeted muscle at the tip by having a user body lie on the selective pressure application device with the tips of each moveable arm contacting the surface of the body where the targeted muscle is located. Each moveable arm rotates around its respective pivot to provide the angular pressure to the targeted muscle.

### CROSS-REFERENCE TO RELATED APPLICATIONS

The present application is a continuation-in-part of U.S. patent application Ser. No. 16/850,801 (Attorney Docket No. KOTHP001) filed on Apr. 16, 2020, and entitled PRESSURE RELEASE AND MASSAGE TOOL, which claims the benefit of priority under 35 U.S.C. § 119(e) to U.S. Provisional Application No. 62/860,222 (KOTHP001P), titled “ILIACUS MUSCLE PRESSURE RELEASE AND MASSAGE TOOL,” filed Jun. 11, 2019, all of which are incorporated herein by reference in their entirety.

### TECHNICAL FIELD

Aspects of the present disclosure relate generally to massage or physical therapy devices, and more particularly apparatuses and methods for trigger point release of muscle groups.

### BACKGROUND

Muscles directly relate to the function of body parts. Therefore tension in the muscles significantly contributes to dysfunction or pain in any areas correlated with the muscles. For example, tightness and excess tension in the iliacus muscle are directly related to the function of the psoas, hip, lower back, pelvis, and leg. By releasing the tension in muscles, such as the iliacus muscle, correlated body parts, such as the hips, can function better and pain can be resolved.

Because muscles can sometimes be hard to access, pain and discomfort have traditionally been addressed by only a handful of skilled practitioners, who use their fingers to put prolonged pressure on the affected muscles to get the muscles to relax. Because of the difficulty in accessing these muscles independently without a practitioner, and the inability for a person to apply sufficient pressure on these muscles independently, it is very difficult for an individual to accomplish relief in these areas without the help of another person. People have tried to use many different kinds of objects in attempts to relieve pain and discomfort in affected muscles with only mediocre effectiveness. Thus, there is a need for an effective way to provide self-applied relief of muscle pain and discomfort.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

Aspects of the present disclosure relate to a neck massager or selective pressure application device. The neck massager or device includes a base, two pivots coupled to the base, and two moveable arms. Each moveable arm is coupled to the base via one of the two pivots. Each moveable arm includes a tip, an extension portion coupled to the tip, and a handle connected to the horizontal portion. The extension portion includes a vertical portion coupled to the tip and a horizontal portion coupled to the vertical portion. Each of the moveable arms is configured to provide angular pressure against a targeted muscle at the tip by having a user body lie on the selective pressure application device with the tips of each moveable arm contacting the surface of the body where the targeted muscle is located. Each moveable arm rotates around its respective pivot to provide the angular pressure to the targeted muscle.

Another aspect of the disclosure relates to a method of using a selective pressure application device to relieve muscle tension. The method comprises positioning the selective pressure application device on a surface or ground and then leaning on the selective pressure application device such that a muscle or muscle group can attain trigger point release. The device includes a base, two pivots coupled to the base, and two moveable arms. Each moveable arm is coupled to the base via one of the two pivots. Each moveable arm includes a tip, an extension portion coupled to the tip, and a handle connected to the horizontal portion. The extension portion includes a vertical portion coupled to the tip and a horizontal portion coupled to the vertical portion. Each of the moveable arms is configured to provide angular pressure against a targeted muscle at the tip by having a user body lie on the selective pressure application device with the tips of each moveable arm contacting the surface of the body where the targeted muscle is located. Each moveable arm rotates around its respective pivot to provide the angular pressure to the targeted muscle.

In some embodiments, at least one moveable arm is configured to swivel in a plane parallel to the ground. In some embodiments, at least one moveable arm is configured to rotate in a plane perpendicular to the ground. In some embodiments, at least one of the pivots is limited in motion by a pivot stop. In some embodiments, each moveable arm is configured to move independently from the other moveable arm. In some embodiments, at least one handle is configured such that the handle is elevated over the extension portion and the tip. In some embodiments, at least one handle is configured to allow the user to push or pull up on the handle in order to maneuver the tip portion into various directions or angles.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The disclosure may best be understood by reference to the following description taken in conjunction with the accompanying drawings, which illustrate particular embodiments of the present disclosure. In the description that follows, like parts are marked throughout the specification and drawings with the same numerals, respectively. The drawing figures are not necessarily drawn to scale and certain figures may be shown in exaggerated or generalized form in the interest of clarity and conciseness.

FIGS. 1A-1B show front and back illustrations of an example muscular system, in accordance with embodiments of the present disclosure.

FIGS. 2A-2B illustrate one exemplary embodiment of a massage device, in accordance with embodiments of the present disclosure.

FIGS. 3A-3I illustrate another exemplary embodiment of a massage device, in accordance with one or more embodiments of the present disclosure.

FIGS. 4A-4D illustrate yet another exemplary embodiment of a massage device, in accordance with one or more embodiments of the present disclosure.

### DETAILED DESCRIPTION

Reference will now be made in detail to some specific examples of the present disclosure including the best modes contemplated for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular interlocking parts or physical compositions. However, it should be noted that the techniques of the present disclosure apply to various other parts or compositions. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

As used herein, the term “tip” will be used interchangeably with “pointed geometry.” As used herein, the term “tool” will be used interchangeably with “device.” As used herein, the term “massage,” is used interchangeably with “trigger point release.”

Various techniques and mechanisms of the present disclosure will sometimes be described in singular form for clarity. However, it should be noted that some embodiments include multiple iterations of a technique or multiple instantiations of a mechanism unless noted otherwise. For example, a device has a tip in a variety of contexts. However, it will be appreciated that a device can have multiple different tips while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a tip may be connected to a base, but it will be appreciated that a variety of extension portions, arms, connectors, bridges, and other features or elements may reside between the tip and the base. Consequently, a connection does not necessarily mean a direct, unimpeded connection unless otherwise noted.

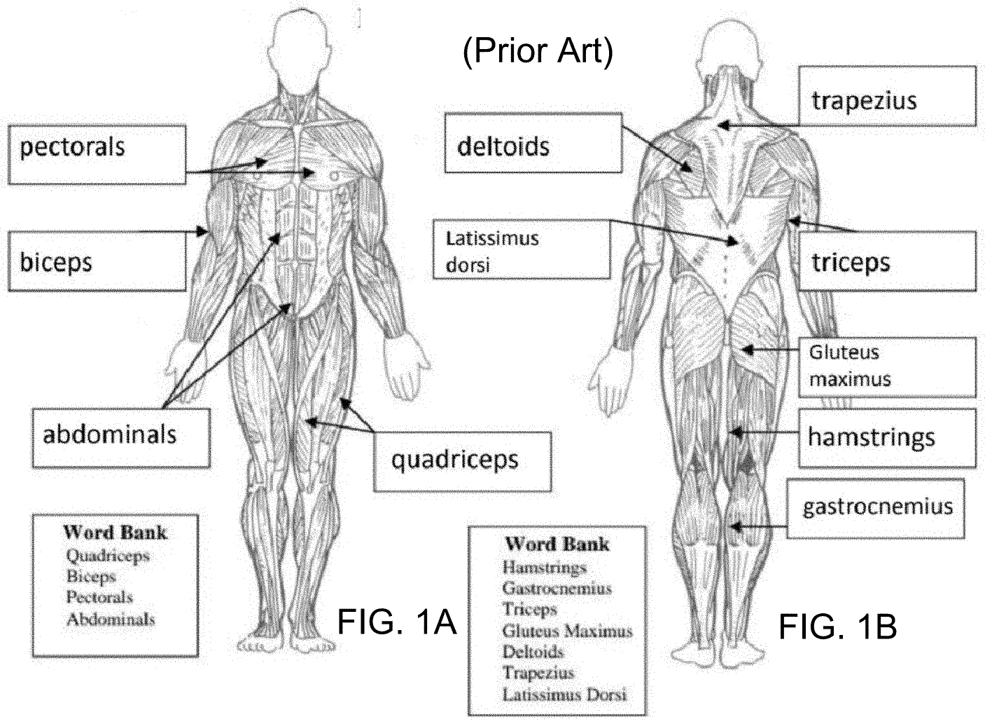

Aspects of the disclosure relate to a massage device usable to stimulate or apply compression to, for example, a portion of muscles or muscle groups. FIGS. 1A-1B show front and back illustrations of a simplified muscular system, in accordance with embodiments of the present disclosure. FIGS. 1A-1B simply show some example muscle groups that can be affected by pressure, pain, and/or discomfort, to which techniques and devices disclosed herein aim to alleviate. For example, the techniques and devices disclosed herein can be used to alleviate pressure or pain in the gluteus maximus, pectorals, quadriceps, and hamstrings. The images in FIGS. 1A-1B are common knowledge, are provided for reference purposes only, and can be found on the Internet, for example at: https://www.cabarrus.k12.nc.us/site/handlers/filedownload.ashx?moduleinstanceid=68833&d ataid=265555&FileName=Muscles%20-%20Workbook.pdf.

One example muscle, or muscle group, which often suffers from tightness is the suboccipital muscles. There are multiple small muscles like the obliquus capitis superior, obliquus capitis inferior, rectus capitis posterior major and rectus capitis posterior minor that make up the suboccipital muscle group. These muscles originate at the occiput of the skull and insert on the cervical vertebrae. The motion of the head on the neck is controlled by these muscles. Tightness in the suboccipital muscle group not only affects the range of motion of the head and neck, but can cause neck pain, headaches, and poor posture. Tightness here also impacts the health of the nervous system as a whole given its close proximity to the brain and spinal cord.

As with many muscles, the suboccipital muscles may tighten or shorten due to various external and/or internal factors. As with many muscles, massaging and/or providing localized pressure to or “releasing” the suboccipital muscle may help to relax or loosen the muscle and/or reduce pain associated with tightness and/or shortening of the muscle. However, because the suboccipital muscles arise from an angled crevice between the skull and the cervical vertebrae, and the muscles themselves are so small, portions of the muscle may be difficult to access by a therapist and/or physician. Further, the affected individual may wish to be able to compress and/or massage their own suboccipital muscle(s) without the need for assistance from others. In addition, there are benefits from compression of the muscles while providing traction of the neck which is, again, difficult to do without assistance from others.

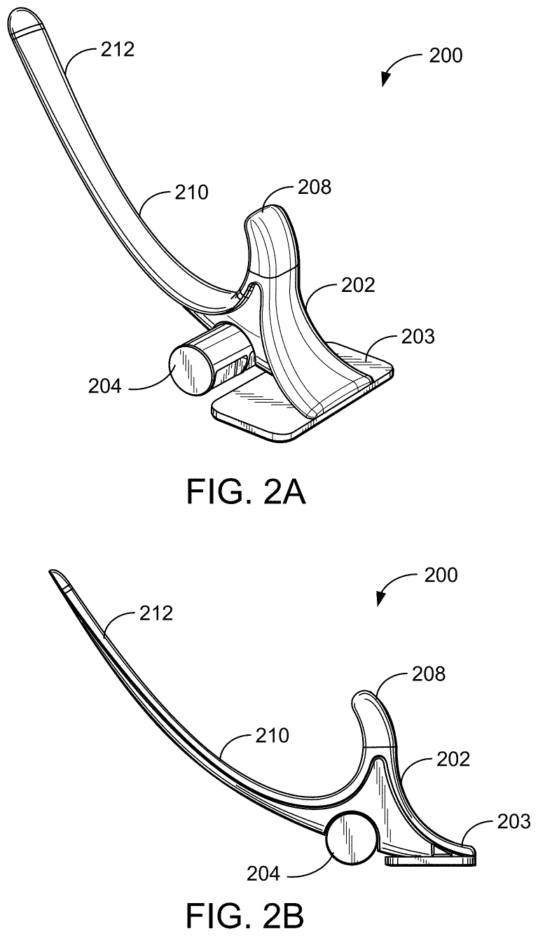

With the aforementioned benefits in mind, aspects of the disclosure relate to a massage device usable to provide localized pressure to any muscle group. FIGS. 2A-2B are diagrams illustrating one example of how a device can alleviate pressure or pain in a muscle group, in accordance with embodiments of the present disclosure. Example aspects of the massage device in accordance with aspects of the present disclosure are described throughout the specification. In the interest of clarity, not all possible features of an actual implementation are described in this specification. It will of course be appreciated that in the development of any such actual implementation, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

FIGS. 2A-2B illustrate a detailed example of an exemplary embodiment of a massage tool/device in accordance with the present disclosure. FIG. 2A illustrates a three dimensional perspective view of an example massage device 200, showing front, left, and top perspective views. Device 200 includes pointed geometry 208, extension portion 202, pivot 204, weight 203, handle 212, and lever arm 210. Pivot 204 is a cylindrical pivot to allow for ease of rotation around the length of the pivot. Weight 203 is a flat heavy square piece to weigh down device 200 while in the neutral stand up position. The flat square shape of weight 203 increases the surface area in contact with the ground, thereby increasing the static friction to help stabilize device 200. Pointed geometry 208 is curved/bent in order to increase the angle of the application of the force. Extension portion 202 has a concave curve on each side of extension portion 202, i.e., the side proximate to lever arm 210 and the side proximate to weight 203. The concave curvature of each side allows for maximum clearance for surrounding body tissue that may fold around extension portion 202 during engagement of pointed geometry 208 with the target muscle group. As demonstrated in FIG. 2A, lever arm 210 and handle 212 are fused into a single curved piece for grip flexibility and maximum leverage. FIG. 2B presents a two dimensional left side view of device 200.

While massage device 200 is designed for use with all muscle groups and body parts, a different embodiment may be better suited for certain specific muscle groups and body parts, such as the neck muscles. There are many muscles in the neck, some on the anterior, lateral, and posterior surfaces. Each one of these small muscles can become tight and it takes a precise angle and tip size to target each of those muscles individually for maximum results. For compression therapy, some muscles, like the longus capitis are best accessed from the lateral neck, whereas others, like the transverospinalis group, are best accessed from the posterior neck. In order to massage or provide compression to each of these muscles individually, a specific location and angle of pressure are needed. For example, one muscle may best benefit from a combination of anterior and lateral pressure from a location of 1 cm from the spinous process where another muscle would benefit from medial pressure only from a distance of 9 cm from the spinous process. Because of the irregular angular nature of the shape of the vertebrae and the varied attachment points and direction of the muscles, in order to access each and every one of these muscles independent of a practitioner, one needs a tool that can not only target each muscle on its own, but can also provide a variety of combinations of angles of pressure. The following embodiments can effectively target each of these muscles with its ability to pivot in different planes, thereby providing pressure in a wide variety of angles.

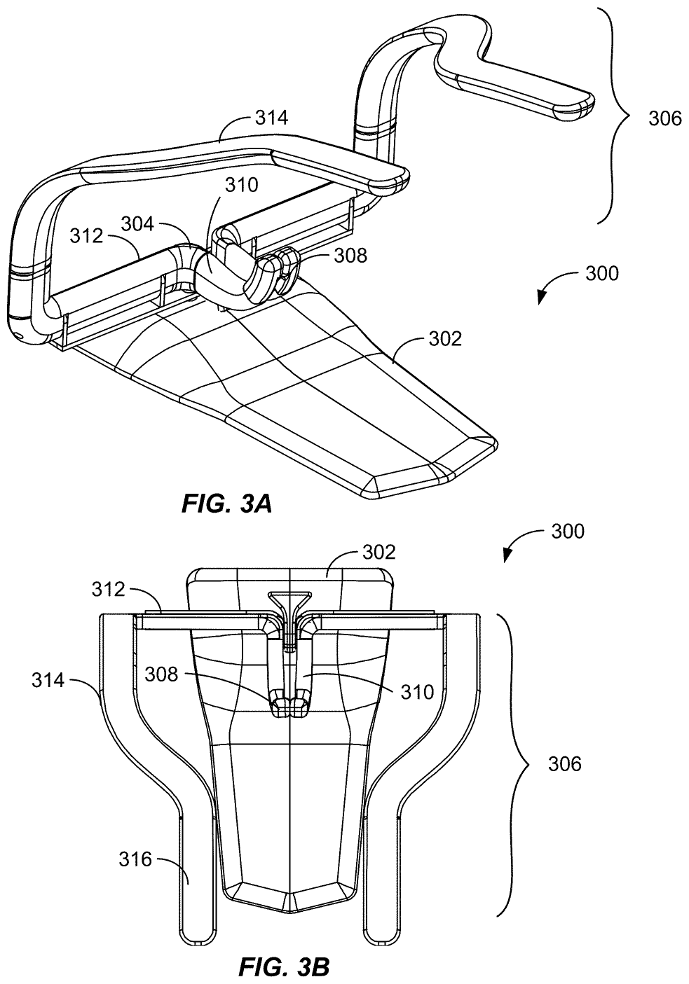

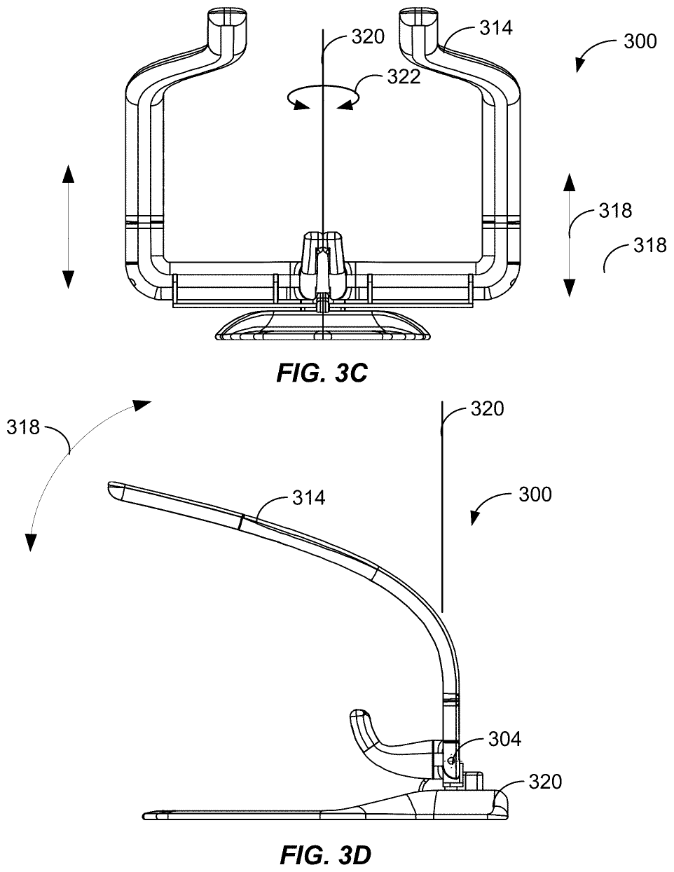

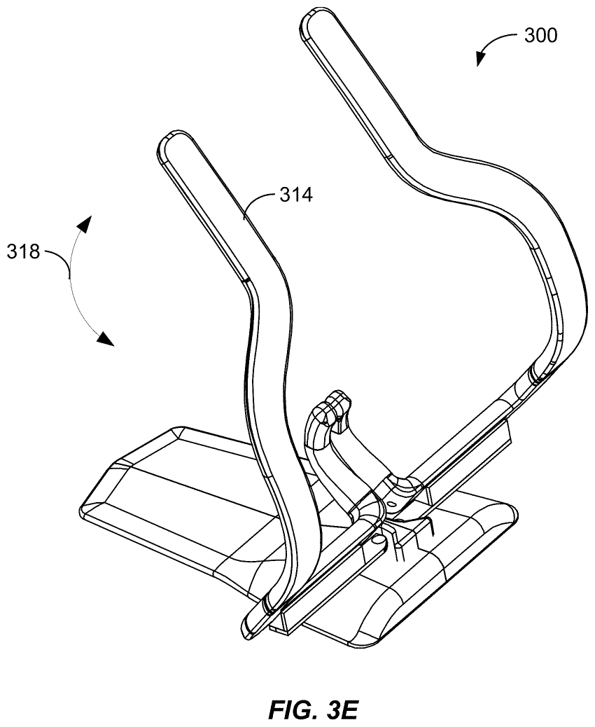

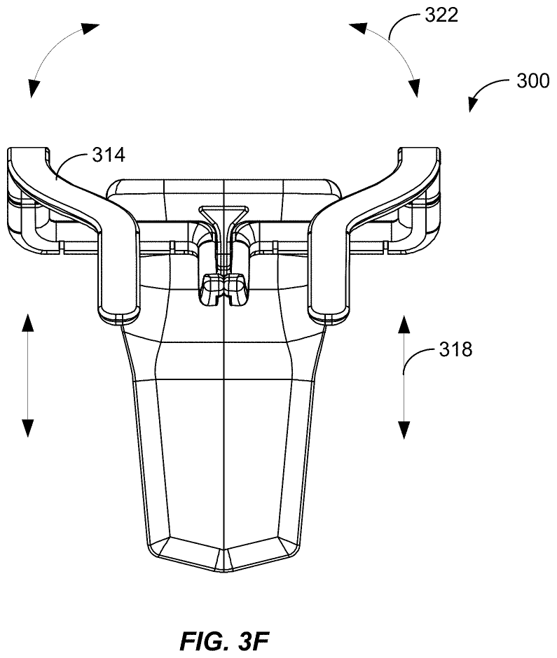

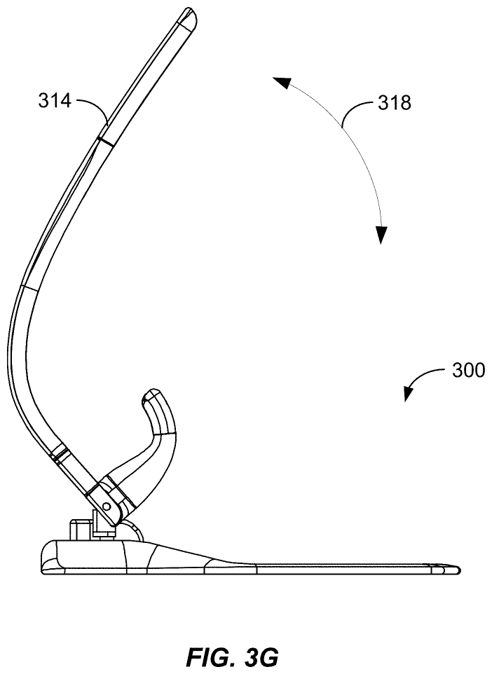

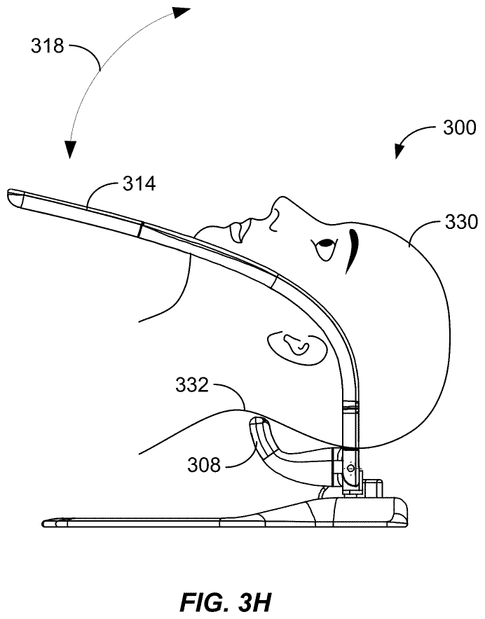

FIGS. 3A-3I illustrate another exemplary embodiment of a massage device, in accordance with one or more embodiments of the present disclosure. FIG. 3A shows a three dimensional perspective view of device 300. Device 300 includes a base 302 that is configured to lay flat on a surface or ground. In some embodiments, device 300 also includes one or more pivots 304 attached to base 302. In some embodiments, device 300 includes two pivots 304. In some embodiments, device 300 also includes one or more moveable arms 306 attached to device 300. In some embodiments, the base is designed to be sturdy enough to hold the pivots/handles and to also stay under the upper back so that device 300 does not shift underneath the user's body when it is in use. In some embodiments, device 300 is configured to have the base be pinned under the shoulders in order to hold device 300 in place.

In some embodiments, device 300 includes two moveable arms 306 attached at pivots 304, with each moveable arm being adjacent to the other and also being a mirror image of the other. In some embodiments, each moveable arm also includes a tip 308 attached to an extension portion of the arm. In some embodiments, the extension portion includes a vertical extension portion 310, and a horizontal extension portion 312. In some embodiments, horizontal extension portion 312 leads into handle 314. In some embodiments, handle 314 rises in a direction perpendicular to the surface or ground and then curves on a gradient into a plane that is parallel or substantially parallel to the ground. As used herein, “substantially” means approximately or very close to being the same. In terms of vectors, a vector can be described as substantially in a first direction if the vector is made up of two components where the component in the first direction is larger than the component in a second direction. For example, if a vector makes a 90 degree angle with the ground, then the vector is comprised of a 100% magnitude component that is perpendicular and a 0% magnitude component that is horizontal. That vector can be described as substantially perpendicular until the angle that the vector makes with the ground becomes 45 degrees or smaller. In some embodiments, the handles are designed to easily hold above the shoulder joint, slightly medial to the shoulder joint, which is the natural place for a bent arm to rest on the chest. In some embodiments, the handles are configured to be closest to the chest as possible so that a user does not need to raise their arms up too far to move the handles and the tip. If the user has to lift their arms too much, the user will have to engage muscles in their shoulder and neck, which is not ideal.

FIG. 3B shows a top down view of device 300. In some embodiments, handle 314 also includes hand grip 316. In some embodiments, the portion of handle 314 that curves on a gradient into the plane that is substantially parallel to the ground also curves inward toward the middle of device 300 to allow for easier grip. In some embodiments, the curvature gives room for a head to fit in between the wider portion of the two moveable arms, while still allowing a closer grip toward the shoulder and neck area.

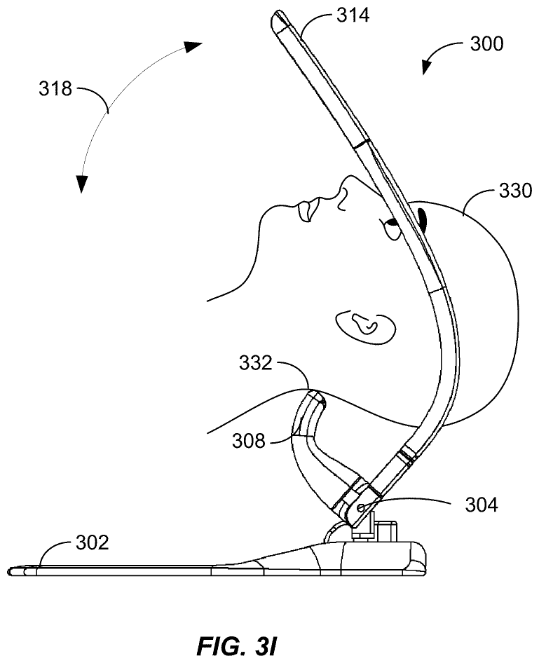

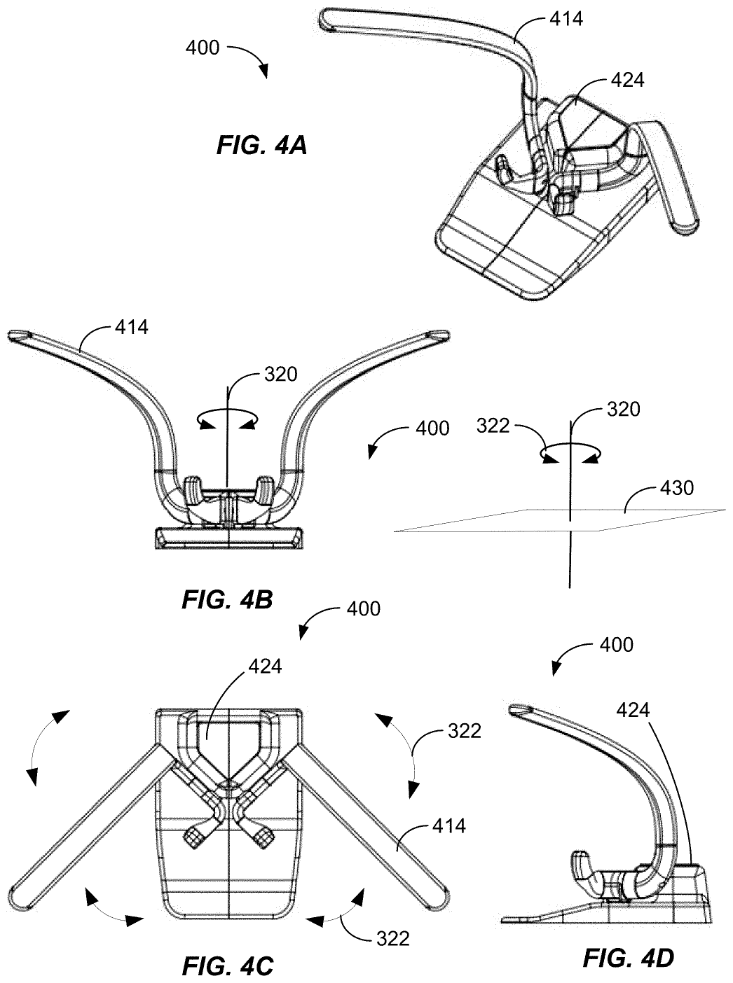

FIG. 3C shows a direct frontal view of device 300. FIG. 3D shows a direct side view of device 300. FIG. 3C shows that each moveable arm 314 can move up and down in a first direction 318. In some embodiments, due to the way that moveable arm 314 is connected to base 302 via pivot 304, as illustrated in FIG. 3D, first direction 318 is actually a curved motion around an x axis, first coming up from the ground and bending toward the perpendicular axis 320, which is perpendicular to the ground. In some embodiments, this pivot around the x axis (horizontal) allows the tips to move upward and rotate to provide angular pressure to the targeted neck muscles. In some embodiments, each moveable arm 314 can also swivel about the pivot in a second direction 322 around perpendicular axis 320 (y axis), thereby making a semi-circular motion in a plane that is parallel to the ground. In some embodiments, this movement is equivalent to splitting the two arms away from each other, as illustrated in FIG. 4C. In some embodiments, this pivot around the y axis (vertical) allows the tips to move closer and further from the spine to target specific muscles with pressure and also allows for lateral pressure into the side of the neck.

In some embodiments, the movement of each of the moveable arms is independent from one another. In some embodiments, the arms move independently so that the user can press on one side of the neck without pressing on the other side. In some embodiments, the movement of each of the moveable arms occurs in two different planes, which allows for three dimensional movement. In some embodiments, each pivot is configured to allow three dimensional movement of the arms. In other embodiments, the three dimensional movement is achieved using multiple pivots 304, with each pivot responsible for a single axis of movement.

FIG. 3E is a perspective view of device 300 showing moveable arms 314 moving in direction 318. FIG. 3F is a perspective view of device 300 showing moveable arms 314 moving in both directions 318 and 322. FIG. 3G shows a side view of device 300 after moveable arm 314 has moved in direction 318 from a resting position. FIG. 3H illustrates a side view of device 300 being in use while the moveable arms 314 are in the resting position. A user 330 lays down on device 300, with the user's neck area 332 touching tip 308. FIG. 3I illustrates a side view of device 300 being in use while the moveable arms 314 are in the lifted position. As shown in FIG. 3I, arms 314 are lifted in direction 318 about pivot 304. During the movement, tip 308 also moves in direction 318 and creates angular pressure into neck area 332 of user 330. In some embodiments, base 302 does not move and stays flat on the surface or ground while the moveable arms 314 move about pivot 304.

FIGS. 4A-4D illustrate yet another exemplary embodiment of a massage device, in accordance with one or more embodiments of the present disclosure. Each of FIGS. 4A-4D shows a different view of device 400. FIGS. 4A-4D show essentially the same features as FIGS. 3A-3I, but with an added pivot stop 424. In some embodiments, pivot stop 424 limits the amount of movement of moveable arms 414 in direction 322 about perpendicular axis 320 in a plane 430 that is parallel to the surface or ground. In such embodiments, limiting the pivot movement helps prevent the moveable arms from hitting the sides of the user's head while the moveable arms are swiveling. In some embodiments, pivot stop 424 is also a head rest.

In some embodiments, the handles need to be hard and able to withstand leverage. Thus, in some embodiments, handles need to be made out of hard plastic, metal, or reinforced plastic. In some embodiments, the tip needs to have a hard substrate with an over-molded rubber to provide hard internal pressure, which gives a hard enough therapeutic pressure to the muscles, whereas the over-molded rubber (70-95 shore) will allow for a touch to the tissue that feels natural like a finger. In some embodiments, plastic alone for the tip feels unnatural and user's body may have a hard time relaxing with just plastic alone. In some embodiments, the base needs to be hard and stable. Thus, in some embodiments, the base is made out of hard plastic but could also be made out of metal, wood, or concrete.

While the examples illustrated in all the figures above show particular combinations of features/elements of devices, it should be noted that any combination of parts, portions, features, or elements from any combination of the figures can also be mixed and matched to achieve an embodiment in accordance with the present disclosure. These examples are all designed with the function of being able to apply pressure to the muscle by either moving the tool into the body or moving the body on the tool.

The foregoing description of various aspects and examples has been presented for purposes of illustration and description. It is not intended to be exhaustive nor to limit the disclosure to the forms described. The aspects(s) illustrated in the figures can, in some instances, be understood to be shown to scale for illustrative purposes. Numerous modifications are possible in light of the above teachings, including a combination of the abovementioned aspects. Some of those modifications have been discussed and others will be understood by those skilled in the art. The various aspects were chosen and described in order to best illustrate the principles of the present disclosure and various aspects as are suited to the particular use contemplated. The scope of the present disclosure is, of course, not limited to the examples or aspects set forth herein, but can be employed in any number of applications and equivalent devices by those of ordinary skill in the art. Rather, it is hereby intended the scope be defined by the claims appended hereto.

What is claimed is:

1. A selective pressure application device, comprising:
a base;
two pivots coupled to the base; and
two moveable arms, wherein each moveable arm is coupled to the base via one of the two pivots, wherein each moveable arm includes:
a tip;
an extension portion coupled to the tip, the extension portion including a vertical portion coupled to the tip and a horizontal portion coupled to the vertical portion; and
a handle connected to the horizontal portion;
wherein each of the moveable arms is configured to provide angular pressure against a targeted muscle at the tip by having a user body lie on the selective pressure application device with the tips of each moveable arm contacting the surface of the body where the targeted muscle is located, wherein each moveable arm rotates around its respective pivot to provide the angular pressure to the targeted muscle.

2. The device of claim 1, wherein at least one moveable arm is configured to swivel in a plane parallel to the ground.

3. The device of claim 1, wherein at least one moveable arm is configured to rotate in a plane perpendicular to the ground.

4. The device of claim 1, wherein at least one of the pivots is limited in motion by a pivot stop.

5. The device of claim 1, wherein each moveable arm is configured to move independently from the other moveable arm.

6. The device of claim 1, wherein at least one handle is configured such that the handle is elevated over the extension portion and the tip.

7. The device of claim 1, wherein at least one handle is configured to allow the user to push or pull up on the handle in order to maneuver the tip portion into various directions or angles.

8. A neck massager comprising:
a base;
two pivots coupled to the base; and
two moveable arms, wherein each moveable arm is coupled to the base via one of the two pivots, wherein each moveable arm includes:
a tip;
an extension portion coupled to the tip, the extension portion including a vertical portion coupled to the tip and a horizontal portion coupled to the vertical portion; and
a handle connected to the horizontal portion;
wherein each of the moveable arms is configured to provide angular pressure against a targeted muscle at the tip by having a user body lie on the selective pressure application device with the tips of each moveable arm contacting the surface of the body where the targeted muscle is located, wherein each moveable arm rotates around its respective pivot to provide the angular pressure to the targeted muscle.

9. The neck massager of claim 8, wherein at least one moveable arm is configured to swivel in a plane parallel to the ground.

10. The neck massager of claim 8, wherein at least one moveable arm is configured to rotate in a plane perpendicular to the ground.

11. The neck massager of claim 8, wherein at least one of the pivots is limited in motion by a pivot stop.

12. The neck massager of claim 8, wherein each moveable arm is configured to move independently from the other moveable arm.

13. The neck massager of claim 8, wherein at least one handle is configured such that the handle is elevated over the extension portion and the tip.

14. The neck massager of claim 8, wherein at least one handle is configured to allow the user to push or pull up on the handle in order to maneuver the tip portion into various directions or angles.

15. A method of using a selective pressure application device to relieve muscle tension, the method comprising:
positioning the selective pressure application device on a surface or ground; and
leaning on the selective pressure application device such that a muscle or muscle group can attain trigger point release,
wherein the selective pressure application device comprises:
a base;
two pivots coupled to the base; and
two moveable arms, wherein each moveable arm is coupled to the base via one of the two pivots, wherein each moveable arm includes:
a tip;
an extension portion coupled to the tip, the extension portion including a vertical portion coupled to the tip and a horizontal portion coupled to the vertical portion; and
a handle connected to the horizontal portion;
wherein each of the moveable arms is configured to provide angular pressure against a targeted muscle at the tip by having a user body lie on the selective pressure application device with the tips of each moveable arm contacting the surface of the body where the targeted muscle is located, wherein each moveable arm rotates around its respective pivot to provide the angular pressure to the targeted muscle.

16. The method of claim 15, wherein at least one moveable arm is configured to swivel in a plane parallel to the ground.

17. The method of claim 15, wherein at least one moveable arm is configured to rotate in a plane perpendicular to the ground.

18. The method of claim 15, wherein at least one of the pivots is limited in motion by a pivot stop.

19. The method of claim 15, wherein each moveable arm is configured to move independently from the other moveable arm.

20. The method of claim 15, wherein at least one handle is configured such that the handle is elevated over the extension portion and the tip.
